(19) United States
(12) Patent Application Publication
(10) Pub. No.: US 2022/0196347 A1
(43) Pub. Date: Jun. 23, 2022

(54) TEMPERATURE CONTROL DEVICE, IN PARTICULAR A COOLING DEVICE FOR A MOTOR VEHICLE

(71) Applicant: Valeo Systemes Thermiques, Le Mesnil Saint-Denis (FR)

(72) Inventors: Fethy Djallal, La Suze Sur Sarthe (FR); Julien Veron, La Suze Sur Sarthe (FR); Marc Herry, La Suze Sur Sarthe (FR); Aurélie Bellenfant, La Suze Sur Sarthe (FR)

(73) Assignee: Valeo Systemes Thermiques, Le Mesnil Saint-Denis (FR)

(21) Appl. No.: 17/604,140

(22) PCT Filed: Apr. 15, 2020
(86) PCT No.: PCT/EP2020/060640

§ 371 Date: Dec. 16, 2021

(30) Foreign Application Priority Data
Apr. 16, 2019 (FR) FR1904053

(51) Int. Cl. F28F 9/02; F28D 1/03; F28F 13/12; H01M 10/625; H01M 10/613

(52) U.S. Cl. CPC F28F 9/0253; F28D 1/035; F28F 13/12; H01M 10/6568; H01M 10/625; H01M 10/613; F28F 9/0256

(57) ABSTRACT

The invention relates to a temperature control device, in particular a cooling device, for an electrical component prone to releasing heat during operation, in particular for an electrical energy storage module, said device comprising an upper plate and a lower plate that is assembled with said upper plate to jointly form a plurality of ducts for the circulation of a heat transfer fluid, in particular a refrigerant fluid, in particular a fluid selected from the refrigerant fluids R134a, R1234yf and R744; in said device, the ducts are grouped into groups of ducts, the ducts of a group extending substantially parallel to one another at a predetermined ‘intra-group distance’ between neighboring ducts; two groups of ducts in which the fluid flows in the same direction being separated from each other by at least one group of ducts in which the fluid flows in the opposite direction, wherein the device comprises a connector (550).

The present invention relates to a temperature control device, in particular a cooling device, in particular for an electrical component capable of releasing heat during its operation, in particular a device for cooling at least one battery or battery cells of a motor vehicle.

Vehicle batteries, in particular for electric vehicles or hybrid vehicles, should as much as possible be maintained at the desired temperature, which is why so-called vehicle battery cooling devices are used. These cooling devices may comprise cooling plates through which a cooling liquid circulates. The cooling plates are installed, as far as possible without gaps, on the outer side of the batteries in order to dissipate heat or else to heat the battery. Cooling devices are known in which the cooling plate is made up of two plate parts which are normally directly fastened to each other. Here, the first plate part is preferably flat, and the second plate part is preferably a stamped or deformed sheet of metal which has meandering depressions. Said depressions are closed by the flat plate part which is fixed to the stamped plate part, so that refrigerant ducts are formed. Patent EP 2 828 922 B1 describes such a device.

Mention may also be made of patent application US2015144314 which describes a battery cooling device with a fluid connection flange.

The invention aims to improve this type of device.

The invention thus proposes a temperature control device, in particular a cooling device, for an electrical component capable of releasing heat during its operation, in particular for an electrical energy storage module, this device comprising an upper plate and a lower plate assembled with the upper plate to form together a plurality of circulation channels for a heat-transfer fluid, in particular a refrigerant fluid, in particular a fluid chosen from the following refrigerant fluids: R134a, R1234yf or R744, in which device the channels are grouped into groups of channels, the channels of a group extending substantially parallel to one another with a predetermined spacing between neighboring channels referred to as the intra-group spacing, two groups of channels that have the same direction of circulation of fluid being separated from one another by at least one group of channels having an opposite direction of circulation of fluid, the device comprising a connector assembled on the upper or lower plate, and designed to create a fluid path for connecting two collecting zones, in particular outlet collecting zones, of two groups of channels having in particular the same direction of circulation, these collecting zones being formed between the two lower and upper plates, this connector comprising an external fluid inlet orifice and an external fluid outlet orifice, one of these two external orifices being in fluidic communication with the fluid path of the connector and the other of the external orifices being in fluidic communication with a fluid collecting zone of an intermediate group of channels which is situated between the two groups of channels which are connected to one another by the fluid path in the connector, this intermediate group in particular having a direction of circulation that is of opposite direction to the other two groups, it being possible for the group or groups of channels to be reduced in number to just one channel if appropriate.

The invention in particular makes it possible, for a reduced packaging and a minimum number of components, using a fluid inlet/outlet connection, to remove fluid from or supply fluid to two nonadjacent zones of the circuit of the temperature control device, which in particular defines a heat exchanger, and to supply fluid to or respectively remove fluid from a zone of the exchanger circuit that is situated between these two adjacent zones.

The invention also permits, for example in the context of a brazed heat exchanger comprising an upper plate, a lower plate, and fluid channels between the two plates, the transfer of fluid via the joining duct from one fluid zone of the exchanger to another, nonadjacent, fluid zone of this exchanger. This duct may be tubular in shape, being for example a tube of oval or round cross section or of rectangular or square cross section, this tube being designed in such a way as to connect the two nonadjacent zones to which fluid is to be supplied or from which fluid is to be removed.

The invention in particular permits the creation of a plate-type cooling heat exchanger for batteries. This exchanger preferably forms part of a refrigerant or liquid circuit.

The invention in particular permits the creation of a circuit of a plate-type device intended to meet the requirements of temperature uniformity in a battery module and between the modules where it is necessary, using a fluid inlet/outlet connection, to remove fluid from or supply fluid to two nonadjacent zones of the circuit of the exchanger and to supply fluid to or respectively remove fluid from a zone situated between these two nonadjacent zones.

The invention, by providing the fluid path between two internal orifices, this path acting as a fluid junction bridge between two zones, permits the use of just one connector, or flange, rather than two single flanges.

According to one aspect of the invention, the connector comprises two internal orifices onto which the fluid path of the connector opens, which path furthermore communicates with one of the external orifices, these internal orifices being positioned respectively opposite two holes in the plate, which holes preferably open onto the associated collecting zones, and the connector comprises a third internal orifice which communicates with the other of the external orifices via a channel in the connector, which channel is in particular cylindrical in shape, this third internal orifice being preferably placed opposite a hole in the plate which opens onto the collecting zone of the intermediate group of channels. In one example of the invention, the connector thus comprises five orifices in all.

According to one aspect of the invention, the internal orifices are on the same face of the connector, which face comes into contact with the plate, and the external orifices are in particular on an opposite face of the connector, in particular so as to allow external ducts, one supplying and the other removing fluid, to be connected to these external orifices.

According to one aspect of the invention, the fluid path comprises a main section perpendicular to the channel opening onto the third internal orifice, this section and this channel being separated from one another.

According to one of the aspects of the invention, the fluid path is formed by a slot made on a body of the connector and closed by a cover fixed in a sealed manner to the body, this cover being in particular of elongate shape.

According to one of the aspects of the invention, the cover comprises a plate designed to be housed at least partially in the slot, this cover being for example welded to the body.

According to one of the aspects of the invention, the cover comprises a tab, in particular of rectangular shape, to be housed in a cutout of a shape complementing the tab.

As a preference, the cover comprises two fixing lugs designed to come to bear in particular against two lateral faces of the body, and these lugs are in particular crimped onto the body.

According to one of the aspects of the invention, the body of the connector is made in particular of aluminum, in particular by extrusion and machining, and the cover is made preferably of aluminum.

According to one of the aspects of the invention, the upper plate has three holes, two of the holes being associated with groups of channels with the same direction of circulation and an intermediate hole, between these two holes, which is associated with a group of fluid channels with the opposite direction, these three holes being in particular aligned.

Another subject of the invention is a system comprising an electrical component capable of releasing heat during its operation, in particular for an electrical energy storage module, and a cooling device described above, designed to cool the component, this component or battery being in thermal contact with the upper plate of the cooling device.

Furthermore, in order to be able to thermally balance a complete system, it is necessary to increase or decrease certain fluid passage cross sections of certain exchangers of the system in order to act accordingly on the flow rate and thus allow thermal balancing.

Concerning the connector as described above, and in the context of a system composed of two or more exchangers of the same version, it is often necessary to modify the diameters of the fluid passage orifices on the connector. The modification on the male flange of a connection bridge, as carried out in series on similar systems, does not make it possible to specifically adjust each inlet orifice of the connector. To do this, either the passage cross sections of the orifices on the upper plate of the exchanger must be modified, or the orifices of the female connector placed on the plate must be modified. In both cases, this makes it necessary to differentiate the exchangers of the same version, which requires differentiating these exchangers and placing the right exchanger in the right place in the system.

The invention also aims to remedy the aforementioned problems.

A subject of the invention is thus a flange of a fluidic connection bridge, the flange configured to be assembled with a connector of a temperature control device, in particular a cooling device, for an electrical component capable of releasing heat during its operation, in particular for an electrical energy storage module, the flange comprising a fluid inlet and a fluid outlet, both configured to be each connected to a respective external duct, or pipe, this flange being designed to distribute a flow of refrigerant fluid coming from the fluid inlet of the flange to at least two distribution orifices of the flange by splitting this flow of refrigerant fluid into at least two fluid flows, the distribution orifices configured to distribute refrigerant fluid respectively to two inlet orifices of the connector on the temperature control device.

The present invention makes it possible in particular to avoid the creation of different references of the same version of exchanger that are used at different positions in the system. The invention proposes in particular to create on the male flange of the connection bridge a bypass function via a fluid path.

The connection bridge is already specific in the system. On the temperature control device or exchanger, there is a female flange, called the higher connector, with three ways, in particular brazed to the exchanger. The calibration of the passage cross sections in order to balance the system can be done on this new flange at the orifices and not modify the orifices of the female flanges of the exchangers. This invention makes it possible in particular to modify the orifices of the flange of the connection bridge without changing that of the female flange associated with the exchanger, which avoids distinguishing the references and avoids the customer having to place them in the system at the appropriate place in the system.

According to one of the aspects of the invention, the flange comprises a fluid path communicating with the fluid inlet of the flange, this fluid inlet being in particular formed by an orifice in the flange, this fluid path being configured to distribute the refrigerant fluid coming from this fluid inlet to the two distribution orifices.

According to one of the aspects of the invention, this flange of the connection bridge comprises a fluid collection orifice configured to collect refrigerant fluid coming from the connector of the temperature control device, this collection orifice communicating with the fluid outlet of the flange via a channel in the flange, the channel being in particular of cylindrical shape, this collection orifice being designed to be placed opposite the fluid outlet orifice of the connector of the temperature control device.

According to one of the aspects of the invention, the fluid distribution and collection orifices on the flange are formed on the same face of the flange, the face coming opposite a face of the connector of the temperature control device, and this face being in particular opposite to a face on which the fluid inlet and outlet of the flange are formed.

According to one of the aspects of the invention, the fluid distribution and collection orifices on the flange each comprise a nozzle, in particular of substantially conical shape, the nozzle configured in each case to cooperate with one of the two inlet orifices and the outlet orifice on the connector of the temperature control device.

According to one of the aspects of the invention, the fluid path in the flange comprises a main section perpendicular to the channel opening onto the collection orifice, this section and this channel being separated from one another.

According to one of the aspects of the invention, the fluid path is formed by a slot made on a body of the flange and closed by a cover fixed in a sealed manner to the body, this cover being in particular of elongate shape. The body is for example formed by extrusion and machining to form the orifices.

In particular, the cover is brazed to the body, for example by induction, laser, friction, heating blade, etc. The cover comprises a plate designed to be housed at least partially in the slot, this cover being for example welded to the body.

The cover can be crimped onto the flange, or body, and fitted with a seal around the perimeter of the cover.

According to one of the aspects of the invention, the cover comprises a tab, in particular of rectangular shape, to be housed in a cutout of a shape complementing the tab.

According to one of the aspects of the invention, the cover comprises two fixing lugs designed to bear in particular on two lateral faces of the body.

According to one of the aspects of the invention, the body of the flange is made in particular of aluminum, in particular by extrusion and machining, and the cover is made in particular of aluminum.

Another subject of the invention is a connection bridge comprising a flange as described above, and two pipes connected to the inlet and to the outlet of the flange, in particular another flange is provided at the other ends of the pipes.

The invention also relates to an assembly comprising the connection bridge as described above, and a temperature control device with a connector assembled with the flange of the connection bridge.

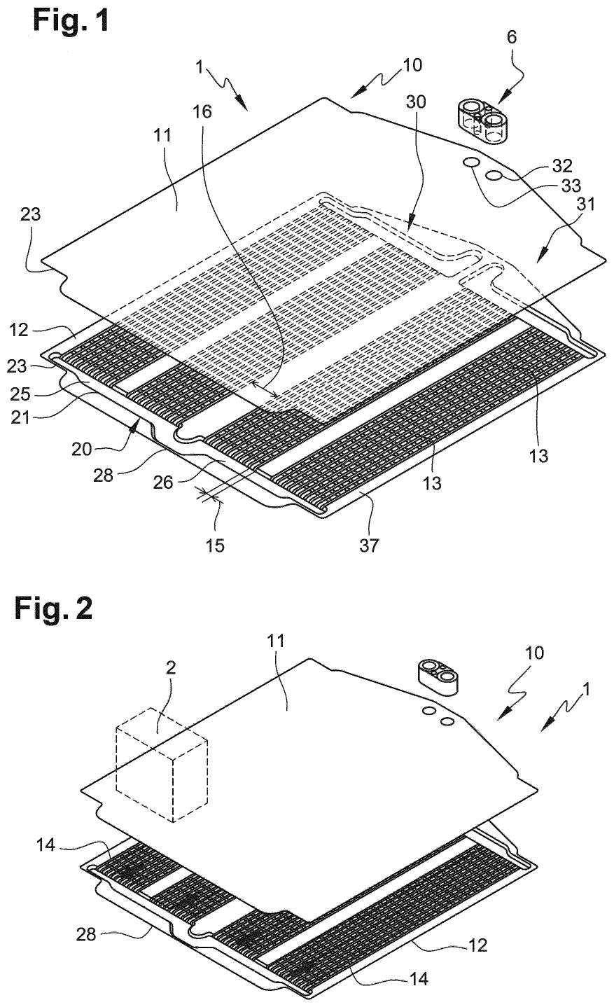

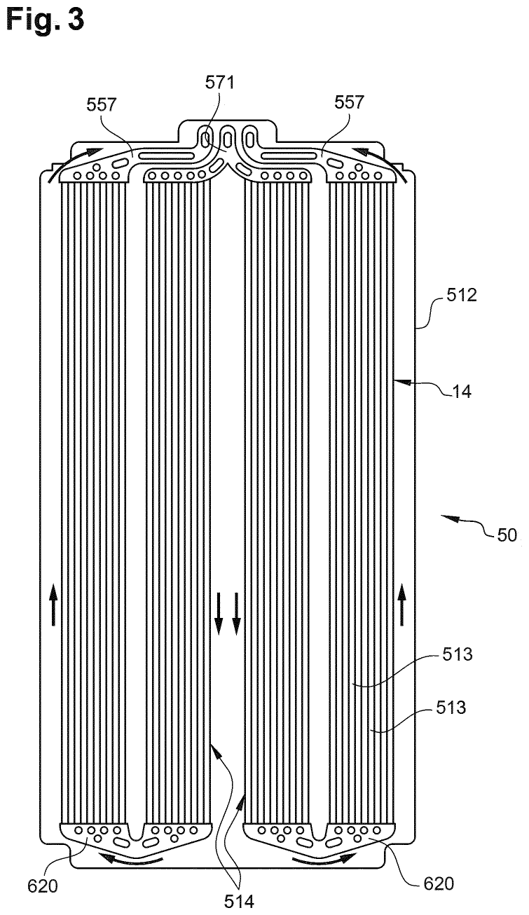

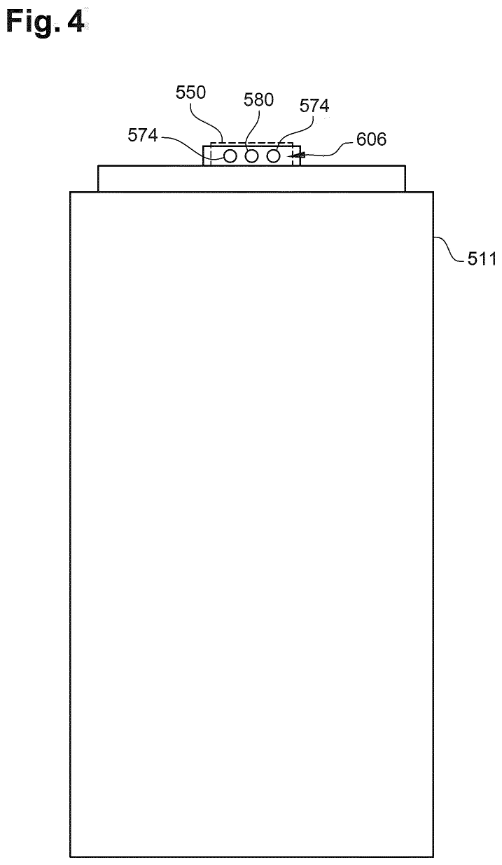

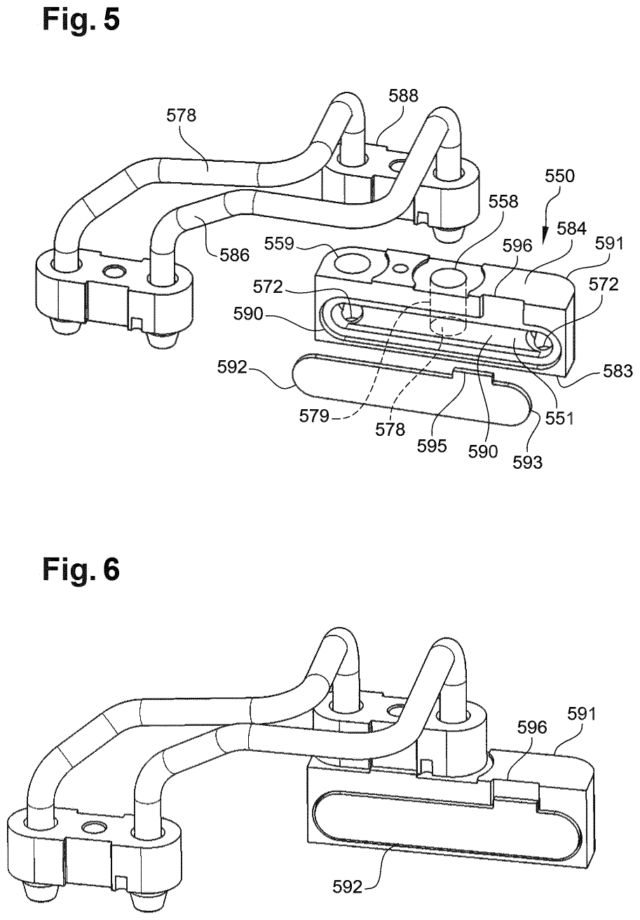

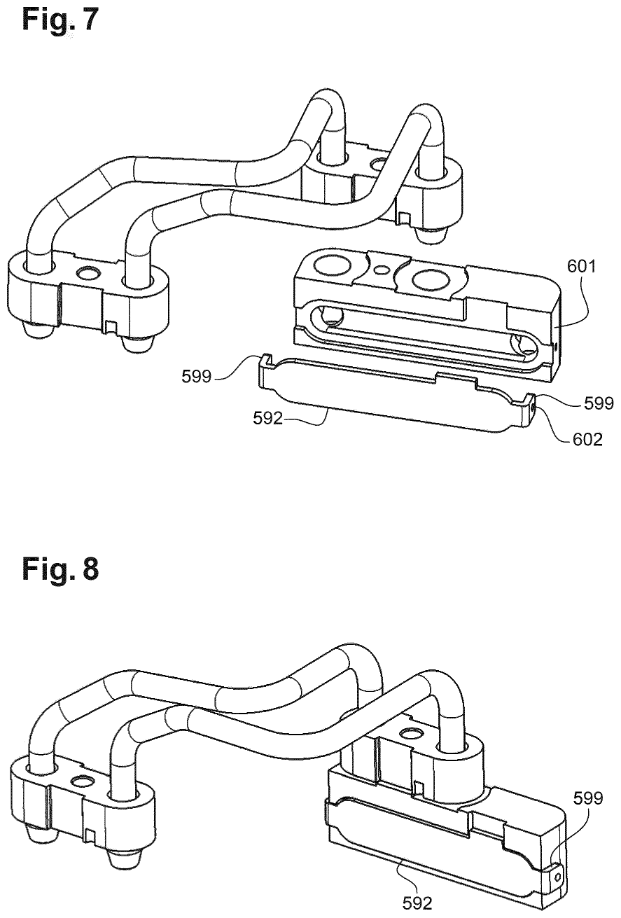

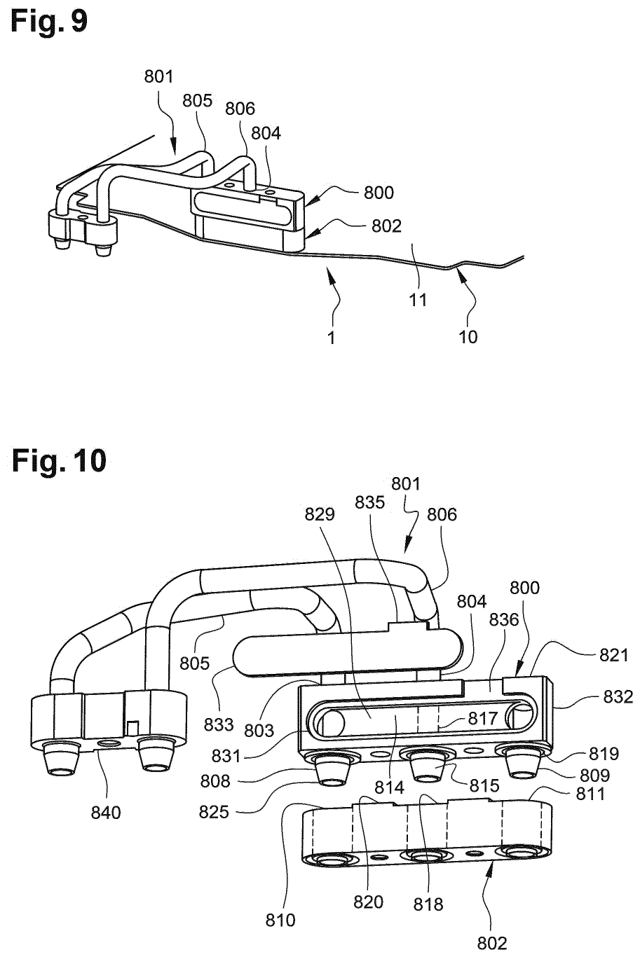

Other features and advantages of the invention will become more clearly apparent from reading the following description, which is given by way of illustrative and nonlimiting example, and the appended drawings, in which:

[FIG. 1] schematically and partially illustrates a device according to one example of the invention,

[FIG. 2] schematically and partially illustrates the device of [FIG. 1] in a different view,

[FIG. 3] schematically and partially illustrates a device according to another example of the invention,

[FIG. 4] schematically and partially illustrates the device of [FIG. 3] in a different view,

[FIG. 5] schematically and partially illustrates a connector of a device according to one example of the invention,

[FIG. 6] schematically and partially illustrates the connector of [FIG. 5] in a different view,

[FIG. 7] schematically and partially illustrates a connector according to another example of the invention,

[FIG. 8] schematically and partially illustrates the connector of [FIG. 7] in a different view,

[FIG. 9] schematically and partially illustrates a connection bridge according to one example of the invention,

[FIG. 10] schematically and partially illustrates an exchanger and the connection bridge according to [FIG. 9].

[FIG. 1] and [FIG. 2] depict a system 1 comprising a set of battery cells 2 to be cooled, for example rowed in two or more rows, and a cooling device 10 designed to cool the cells 2, which are in thermal contact with an upper plate of the cooling device 10, as explained below.

The temperature control device 10 comprises an upper plate 11, a lower plate 12 assembled with the upper plate 11 so as together to form a plurality of circulation channels 13 for a heat-transfer fluid, in particular a refrigerant fluid, in particular a fluid chosen from the following refrigerant fluids: R134a, R1234yf or R744. The channels 13 are grouped into groups 14 of channels, the channels of a group extending substantially parallel to one another with a predetermined spacing between neighboring channels, called the intra-group spacing 15, the intra-group spacing being strictly less than the spacing between two groups of neighboring channels, called the intergroup spacing 16. The channels 13 each have a cross section of between 1 mm² and 9 mm². The channels 13 all have the same cross section and are rectilinear. The channels 13 extend substantially over the entire length of the plates. The groups 14 of channels are arranged side by side and have the same length. The intra-group spacing 15 between the different channels 13 of the same group of channels is constant, in the example considered. The intergroup spacing 16 between the different groups of channels is constant, in the example considered. The cooling device comprises a diverting chamber 20 designed to conduct the fluid leaving one of the groups 14 of channels toward one of the other groups of channels. All the channels 13 of the group open onto this diverting chamber. The diverting chamber 20 is formed by the upper 11 and lower 12 plates, for example made of aluminum. The lower plate 12 comprises a stamped zone 21 designed to participate in the formation of the diverting chamber 20. The stamped zone 21 is closed with the other of the plates 11, which is flat, to form the diverting chamber 20. The diverting chamber 20 extends over one side 23 of the plates. The device has four groups 14 of channels. The number of groups of channels dedicated to circulation of refrigerant fluid in one direction is equal to the number of groups of channels dedicated to the circulation of fluid in the opposite direction. Two groups 14 of channels with the same direction of fluid circulation open onto the diverting chamber. These two groups of channels are neighbors on one half of the plates. The diverting chamber 20 is fluidically connected to two other groups 14 of channels which are designed to receive the refrigerant fluid leaving the diverting chamber. These two groups of channels are neighbors on the other half of the plates. Thus, four groups of channels are connected to the common diverting chamber 20. The two groups 14 of inlet channels arriving at the diverting chamber 20 are arranged on one branch 25 of the diverting chamber, and the two groups of outlet channels leaving the diverting chamber are arranged on another branch 26 of the diverting chamber. The direction of circulation of the fluids is indicated by arrows. These branches 25 and 26 of the diverting chamber 20 are substantially rectilinear, and perpendicular to the channels. An elbow 28 is designed to connect the two branches 25 and 26 of the diverting chamber. The cooling device comprises an inlet zone 30 for refrigerant fluid entering the channels, this inlet zone being formed between the two plates 11 and 12. This fluid inlet zone 30 is designed to supply all the fluid circulation channels 13 which open onto the diverting chamber 20, namely the channels in which the fluid flows toward the diverting chamber. This inlet zone 30 is common to the groups 14 of channels. The cooling device comprises an outlet zone 31 for refrigerant fluid leaving the channels, this outlet zone being formed between the two plates 11 and 12. This fluid outlet zone 31 is designed to conduct the fluid leaving all the fluid circulation channels 13 which originate from the diverting chamber. This outlet zone 31 is common to the two groups of channels. The inlet 30 and outlet 31 zones are adjacent to an inlet 32 and outlet 33 orifice respectively. The inlet 32 and outlet 33 orifices are connected to a pipe connector block 6. The lower plate 2 comprises zones of rounded cross section, in particular stamped zones, to form the channels 13 with the upper plate. The inlet 30 and outlet 31 zones include stamped zones of the lower plate 12. Preferably, the heat-transfer fluid can be chosen from the refrigerant fluids with the designation R134a, R1234yf or R744. The heat-transfer fluid used is alternatively glycol water, without limitation on the glycol content (0% to 100%). The battery cells comprise, for example, a plurality of lithium-ion (Li-ion) batteries for use in a hybrid vehicle. In another embodiment, the plurality of battery cells are Li-ion batteries for use in a battery-powered electric vehicle. The diverting chamber 20 and/or the inlet zone 30 and/or the outlet zone 31 include(s), where appropriate, reinforcing elements to reinforce the mechanical strength in these zones, which are potentially of larger cross section.

[FIG. 3] and [FIG. 4] depict another embodiment of the invention, namely a temperature control device 50, in this instance a cooling device, for an electrical energy storage module, this device comprising an upper plate 511 and a lower plate 512 assembled with the upper plate 511 so as together to form a plurality of circulation channels 513 for a heat-transfer fluid, in which device the channels are grouped into groups 14 of channels, the channels of a group extending substantially parallel to one another with a predetermined spacing between neighboring channels, two groups 14 of channels that have the same direction of circulation of fluid being separated from one another by two neighboring groups 614 of channels having an opposite direction of circulation of fluid.

Diverting chambers 620 are provided, at one of the ends of the channels 13, to connect one of the groups of channels 14 to the neighboring group of channels 614 via a 180° diverting bend.

The device 50 comprising a connector 550 assembled on the upper plate 511, as illustrated in [FIG. 4] and in [FIG. 5] as well as in [FIG. 6].

This connector 550 is designed to create a fluid path 551 for connecting two outlet collecting zones 557 of two groups of channels 14 having the same direction of circulation illustrated by arrows, these collecting zones 557 being formed between the two lower 512 and upper 511 plates, this connector 550 comprising an external fluid inlet orifice 558 and an external fluid outlet orifice 559, the external outlet orifice 559 being in fluidic communication with the fluid path 551 of the connector and the other of the external orifices 558 being in fluidic communication with a fluid collecting zone 571 of the intermediate group 614 of channels which is situated between the two groups of channels 14 which are connected to one another by the fluid path 551 in the connector 50.

The connector 50 has two internal orifices 572 onto which the fluid path 551 of the connector opens, which path also communicates with the external orifice 559, these internal orifices 572 being placed opposite two holes 574 respectively in the plate 511, which holes open onto the associated collecting zones 557, and the connector 550 has a third internal orifice 578 which communicates with the other of the external orifices 558 via a cylindrical straight channel 579 in the connector, this third internal orifice 558 being placed opposite a hole 580 in the plate 511 which opens onto the collecting zone 571 of the intermediate group of channels. In one example of the invention, the connector 550 thus comprises five orifices in all, namely 558, 559, two of 572, and 578.

The internal orifices 572 and 578 are on the same face 583 of the connector, which face comes into contact with the plate, and the external orifices 558 and 559 are on an opposite face 584 of the connector, so as to allow external ducts 586 and 587, one, 586, supplying fluid and the other, 587, removing fluid, to be connected to these external orifices. These ducts are fixed to a common flange 588 and connected to a fluid circuit.

The fluid path 551 comprises a main section 590 perpendicular to the channel 579 opening onto the third internal orifice 578, this straight section 590 and this channel 579 being separated from one another.

The fluid path 551 is formed by a slot 590 cut into a body 591 of the connector and closed by a cover 592 fixed in a sealed manner to the body, this cover 592 being of elongate shape corresponding substantially to the mouth of the slot 590.

The cover 592 comprises a plate 593 designed to be housed at least partially in the slot 590, this cover 592 being, for example, welded to the body 591.

The cover 592 comprises a tab 595, of rectangular shape, to be housed in a cutout 596 of a shape complementing the tab.

As a variant, as illustrated in [FIG. 7] and in [FIG. 8], the cover 592 comprises two lateral fixing lugs 599 designed to come to bear against two lateral faces 601 of the body. The cover 592 is maintained on the body by crimping the lateral lugs 599 at the zones 602.

The body 591 of the connector is made in particular of aluminum, in particular by extrusion and machining, and the cover 592 is made of aluminum.

The upper plate 511 has three holes 574 and 580, two of the holes being associated with groups of channels with the same direction of circulation and an intermediate hole, between these two holes, which is associated with a group of fluid channels with the opposite direction, these three holes being in particular aligned. These holes are, for example, on a narrowed region 606 of the plate 511.

There is shown in [FIG. 9] and [FIG. 10] a flange 800 of a fluidic connection bridge 801, the flange 800 configured to be assembled with a connector 802 of a cooling temperature control device 10 for an electrical energy storage module, the flange 800 comprising a fluid inlet 803 and a fluid outlet 804, both configured to be each connected to a respective external duct 805 and 806, or pipe, this flange 800 being designed to distribute a flow of refrigerant fluid coming from the fluid inlet 803 of the flange to at least two distribution orifices 808 and 809 of the flange by splitting this flow of refrigerant fluid into at least two fluid flows, the distribution orifices 808 and 809 configured to distribute refrigerant fluid respectively to two inlet orifices 810 and 811 of the connector 802 on the temperature control device 10.

The connection bridge is already specific in the system. On the temperature control device or exchanger, there is a female flange, called the higher connector, with three ways, in particular brazed to the exchanger. The calibration of the passage cross sections in order to balance the system can be done on this new flange at the orifices and not modify the orifices of the female flanges of the exchangers. This invention makes it possible in particular to modify the orifices of the flange of the connection bridge without changing that of the female flange associated with the exchanger, which avoids distinguishing the references and avoids the customer having to place them in the system at the appropriate place in the system.

The flange 800 comprises a fluid path 814 communicating with the fluid inlet 803 of the flange, this fluid inlet being formed by an orifice in the flange, this fluid path being configured to distribute the refrigerant fluid coming from this fluid inlet to the two distribution orifices 808 and 809.

This flange 800 of the connection bridge has a fluid collection orifice 815 configured to collect refrigerant fluid coming from the connector 802 of the temperature control device, this collection orifice 815 communicating with the fluid outlet 804 of the flange 800 via a channel 817 in the flange, the channel being of cylindrical shape, this collection orifice 815 being designed to be placed opposite the fluid outlet orifice 818 of the connector 802 of the temperature control device.

The fluid distribution 808 and 809 and collection 815 orifices on the flange 800 are formed on the same face 819 of the flange, the face coming opposite a face 820 of the connector of the temperature control device, and this face 819 being in particular opposite to a face 821 on which the fluid inlet 803 and outlet 804 of the flange are formed.

The fluid distribution 808 and 809 and collection 815 orifices on the flange 800 each comprise a nozzle 825 in particular of substantially conical shape, the nozzle configured to in each case cooperate with one of the two inlet orifices 810 and 811 and the output orifice 818 on the connector of the temperature control device 10.

The fluid path 814 in the flange 800 comprises a main section 829 perpendicular to the channel 817 opening onto the collection orifice 815, this section and this channel being separated from one another.

The fluid path 814 is formed by a slot 831 produced on a body 832 of the flange and closed by a cover 833 fixed in a sealed manner to the body 832, this cover being of elongate shape. The body 832 is for example formed by extrusion and machining to form the orifices.

In particular, the cover 833 is brazed to the body 832, for example by induction, laser, friction, heating blade, etc. The cover 833 comprises a plate designed to be housed at least partially in the slot, this cover being, for example, welded to the body.

According to one of the aspects of the invention, the cover 833 comprises a tab 835, in particular of rectangular shape, to be housed in a cutout 836 of complementary shape to the tab.

According to one of the aspects of the invention, the body of the flange is made in particular of aluminum, in particular by extrusion and machining, and the cover is made in particular of aluminum.

The connection bridge 801 comprising the flange 800 and the two pipes 805 and 806 connected to the inlet and to the outlet of the flange, another flange 840 is provided at the other ends of the pipes 805 and 806.

The connector 802 has two internal orifices 572 onto which the fluid path 814 of the connector opens, which path further communicates with the inlet orifice 810 and 811, these internal orifices being placed opposite two holes 574 respectively in the plate 511, which holes open onto the associated collecting zones 557, and the connector 802 has a third internal orifice 578 which communicates with the outlet orifice 818 via a cylindrical straight channel in the connector, this third internal orifice being placed opposite a hole 580 in the plate 511 which opens onto the collecting zone 571 of the intermediate group of channels. In this example of the invention, the connector 802 thus comprises a total of six fluid orifices.

The flange 800 has, for its part, five fluid orifices as described above.

1. A flange of a fluidic connection bridge, the flange configured to be assembled with a connector of a temperature control device, for an electrical component capable of releasing heat during its operation, the flange comprising:
a fluid inlet and a fluid outlet, both configured to be each connected to a respective external duct, or pipe,
the flange being configured to distribute a flow of refrigerant fluid coming from the fluid inlet of the flange to at least two distribution orifices of the flange by splitting this flow of refrigerant fluid into at least two flows of fluid, distribution orifices configured to distribute refrigerant fluid respectively to two inlet orifices of the connector on the temperature control device.

2. The flange as claimed in claim 1, further comprising: a fluid path communicating with the fluid inlet of the flange, this fluid inlet being formed by an orifice in the flange, this fluid path being configured to distribute the refrigerant fluid coming from this fluid inlet to the two distribution orifices.

3. The flange as claimed in claim 2, further comprising: a fluid collection orifice configured to collect refrigerant fluid coming from the connector of the temperature control device, the collection orifice communicating with the fluid outlet of the flange via a channel in the flange, the channel being of cylindrical shape, this collection orifice being to be placed opposite the fluid outlet orifice of the connector of the temperature control device.

4. The flange as claimed in claim 3, wherein its fluid distribution and collection orifices on the flange are formed on the same face of the flange, the face coming opposite a face of the connector of the temperature control device, and the face being opposite to a face on which the fluid inlet and outlet of the flange are formed.

5. The device as claimed in claim 2, wherein the fluid path in the flange comprises a main section perpendicular to the channel opening onto the collection orifice, the section and the channel being separated from each other.

6. The flange as claimed in claim 2, wherein the fluid path is formed by a slot made on a body of the flange and closed by a cover fixed in a sealed manner to the body, the cover being in particular of elongate shape.

7. The flange as claimed in claim 6, wherein the cover comprises a plate configured to be housed at least partially in the slot, this cover being for example welded to the body.

8. A connection bridge comprising: a flange as claimed in claim 1; and two pipes connected to the inlet and to the outlet of the flange, wherein another flange is provided at the other ends of the pipes.

9. An assembly comprising:
the connection bridge as claimed in claim 8; and
a temperature control device with a connector assembled with the flange of the connection bridge.
